(19) United States
(12) Patent Application Publication
(10) Pub. No.: US 2025/0341392 A1
(43) Pub. Date: Nov. 6, 2025

(54) ULTRA-HIGH SPATIAL RESOLUTION STRUCTURED LIGHT SCANNER AND APPLICATIONS THEREOF

(71) Applicant: VIRGINIA TECH INTELLECTUAL PROPERTIES, INC., Blacksburg, VA (US)

(72) Inventors: Rongxuan Wang, Blacksburg, VA (US); Zhenyu Kong, Blacksburg, VA (US)

(21) Appl. No.: 18/854,362

(22) PCT Filed: Feb. 10, 2023
(86) PCT No.: PCT/US2023/062413

§ 371 Date: Oct. 4, 2024

Related U.S. Application Data
(60) Provisional application No. 63/329,500, filed on Apr. 11, 2022.

(51) Int. Cl. G01B 11/25

(52) U.S. Cl. CPC G01B 11/2545; G01B 11/2504; G01B 11/2513

(57) ABSTRACT

A structured light three-dimensional scanner (SLS) is described for digitally reconstructing surface topography useful in additive manufacturing (A.M) processes. In an example, the structured light three-dimensional scanner includes a first imaging device having a first lens, a second imaging device having a second lens, and a controller, where the first imaging device and the second imaging device collectively have a field-of-view less than or equal to 50×50 mm. The controller is configured to direct the first imaging device and the second imaging device to capture calibration images of a calibration target, the calibration target having a predetermined pattern thereon, calibrate the structured light three-dimensional scanner using the calibration images, direct the first imaging device and the second imaging device to capture images of the object to be scanned, and perform triangulation based on the images captured of the object to generate three-dimensional data of the object.

### CROSS-REFERENCE TO RELATED APPLICATION

The present disclosure claims the benefit of and priority to U.S. Provisional Patent Application No. 63/329,500 filed Apr. 11, 2022, entitled “ULTRA-HIGH SPATIAL RESOLUTION STRUCTURED LIGHT 3D SCANNER,” the contents of which being incorporated by reference in their entirety herein.

### GOVERNMENT LICENSE RIGHTS

This invention was made with government support under Grant No. N00014-18-1-2794 awarded by the Office of Naval Research. The government has certain rights in the invention.

### BACKGROUND

Digital three-dimensional (3D) scanning is a metrology method where surface topography is digitally reconstructed, ideally with high-precision and accuracy. Such methods assist traditional manufacturing processes evolve into a smart manufacturing paradigm, which can ensure product quality through automated sensing and control. However, due to limitations with spatial resolutions, scanning speeds, and sizes of a focusing area, existing systems cannot be used for in-process monitoring in smart manufacturing.

### BRIEF SUMMARY

Various aspects of a structured light three-dimensional scanner having high spatial resolution, as well as applications thereof, are described. In a first aspect, a method for scanning an object is described that includes providing a structured light three-dimensional scanner (SLS) comprising: a first imaging device having a first lens, a second imaging device having a second lens, a controller, and, in some implementations, a projector. The first imaging device and the second imaging device may collectively have a field-of-view less than or equal to 50×50 mm. The method further includes capturing, by the first imaging device and the second imaging device, calibration images of a calibration target having a predetermined pattern thereon; calibrating, by the controller, the structured light three-dimensional scanner using the calibration images; capturing, by the first imaging device and the second imaging device, images of the object to be scanned; and performing, by the controller, triangulation based on the images captured of the object to generate three-dimensional data of the object. The three-dimensional data may have a spatial resolution of 2 to 50 μm.

The structured light three-dimensional scanner may further include a projector. Accordingly, the method may further include directing, by the controller, the projector to project the predetermined pattern onto the calibration target, and capturing, by the first imaging device and the second imaging device, the calibration images of the calibration target as the predetermined pattern is projected on the calibration target by the projector.

In some aspects, capturing the calibration images of the calibration target may further include directing, by the controller, a lighting device to project light parallel to the calibration target. The lighting device may include a polarizer configured to enhance beam parallelism. Capturing the calibration images of the calibration target may include directing, by the controller, the projector to project light on the calibration target, and directing, by the controller, a lighting device separate from the projector to project light parallel to the calibration target. Further, capturing the calibration images of the calibration target may further include adjusting an exposure time of at least one of the first imaging device and the second imaging device to perform overexposure while capturing the calibration images.

In some aspects, the calibration target is a substrate having the predetermined pattern formed thereon, and wherein the predetermined pattern is one of: a sinusoidal fringe pattern, and a checkerboard pattern. The substrate is a ceramic and/or transparent substrate (e.g., a soda-lime glass substrate) and the predetermined pattern may be formed of a metallic material (e.g., chrome) through physical vapor deposition (PVD). The method may further include generating the three-dimensional data of the object during an additive manufacturing or three-dimensional printing process in which another object separate from the object being scanned is formed.

In a second aspect, a system for scanning an object is described that includes a structured light three-dimensional scanner (SLS) comprising: a first imaging device having a first lens, a second imaging device having a second lens, and a controller. The first imaging device and the second imaging device may collectively have a field-of-view less than or equal to 50×50 mm. The controller is configured to: direct the first imaging device and the second imaging device to capture calibration images of a calibration target, the calibration target having a predetermined pattern thereon; calibrate the structured light three-dimensional scanner using the calibration images; direct the first imaging device and the second imaging device to capture images of the object to be scanned; and perform triangulation based on the images captured of the object to generate three-dimensional data of the object. The three-dimensional data may have a spatial resolution of 2 to 50 μm.

In some aspects, the structured light three-dimensional scanner includes a projector, and the controller is further configured to direct the projector to project the predetermined pattern onto the calibration target, and direct the first imaging device and the second imaging device to capture the calibration images of the calibration target as the predetermined pattern is projected on the calibration target by the projector. The controller may be further configured to direct a lighting device to project light parallel to the calibration target, and direct the first imaging device and the second imaging device to capture the calibration images of the calibration target as the lighting device projects the light parallel to the calibration target. The lighting device may include a polarizer configured to enhance beam parallelism.

The controller may be further configured to: direct the projector to project light on the calibration target, and direct a lighting device separate from the projector to project light parallel to the calibration target as the calibration images are captured by the first imaging device and the second imaging device. The controller may be further configured to adjust an exposure time of at least one of the first imaging device and the second imaging device to perform overexposure as the calibration images are captured by the first imaging device and the second imaging device.

In some aspects, the calibration target is a substrate having the predetermined pattern formed thereon, and wherein the predetermined pattern is a checkerboard pattern. For instance, the substrate may be a ceramic and/or transparent substrate (e.g., soda-lime glass substrate) and the predetermined pattern is formed of a metallic material through physical vapor deposition (PVD).

In various aspects, the system further includes an additive manufacturing device (e.g., a three-dimensional printer), where the controller is configured to generate the three-dimensional data of the object during an additive manufacturing process in which another object separate from the object being scanned is formed by the additive manufacturing device and communicate the three-dimensional data to the additive manufacturing device as the other object is formed.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a high-resolution optical camera image on an object manufactured according to an additive manufacturing process having a callout region illustrating a microscopic view of a melt pool of the object.

FIG. 2A illustrates a non-limiting embodiments of a dual-camera structured light three-dimensional scanner in accordance with various embodiments of the present disclosure.

FIG. 2B illustrates an example of a checkerboard calibration target with 15 mm squares in accordance with various embodiments of the present disclosure.

FIG. 3A illustrates a relationship between a field-of-view, a working distance, a focal length, a pixel size, a sensor size, and spatial resolution in accordance with various embodiments of the present disclosure.

FIG. 3B illustrates various methods for improving spatial resolution in accordance with various embodiments of the present disclosure.

FIG. 4A is a focused projected image having a projected pattern with discrete sinusoidal grayscale, which results from a pixelated image in accordance with various embodiments of the present disclosure.

FIG. 4B is a slightly defocused projected image having a projected pattern with a near smooth sinusoidal grayscale pattern, where the pixel resolution of the projected image is near infinite in accordance with various embodiments of the present disclosure.

FIG. 5 shows various USAF 1951 Resolving Power Tests on a selected lens image in accordance with various embodiments of the present disclosure.

FIGS. 6A-6D illustrate differing calibration patten and target resolutions in accordance with various embodiments of the present disclosure.

FIG. 7A is an example of a calibration pattern in accordance with various embodiments of the present disclosure.

FIG. 7B is a calibration target sample including a ceramic substrate having a predetermined calibration pattern etched thereon in accordance with various embodiments of the present disclosure.

FIG. 8A is an ideal calibration image in accordance with various embodiments of the present disclosure.

FIG. 8B is a section of an experimental calibration image having various imperfections in accordance with various embodiments of the present disclosure.

FIG. 8C is an illustration of spherical area reflection from a projector to an imaging device in accordance with various embodiments of the present disclosure.

FIG. 9A shows an experimental calibration image captured using a parallel lighting source, where the intensity of the bright spots has been reduced in accordance with various embodiments of the present disclosure.

FIG. 9B shows an experimental calibration image captured using a parallel lighting source after adjusting a polarizer, where the number of bright spots on the surface is largely reduced in accordance with various embodiments of the present disclosure.

FIG. 9C is an illustration of axial chromatic aberration due to a lens not being able to focus different colors on the same plane.

FIG. 10A is an experimental calibration image before applying any noise reduction methods.

FIG. 10B is an experimental calibration image showing a significant reduction of color impurity after applying noise reduction methods in accordance with various embodiments of the present disclosure.

FIG. 10C is a scanning result of a flat surface based on high-noise calibration images like that shown in FIG. 10A in accordance with various embodiments of the present disclosure.

FIG. 10D is a scanning result of the same surface of FIG. 10C by using the improved calibration images like that shown in FIG. 10B in accordance with various embodiments of the present disclosure.

FIG. 12 is a photograph of a prototype of a dual-camera structured light three-dimensional scanner in accordance with various embodiments of the present disclosure.

FIG. 12B is an enlarged photograph of a modified tiny-area projector, where a focal length of an original lens of the projector was increased by adding a spacer in accordance with various embodiments of the present disclosure.

FIG. 13 shows, from left to right, a scan using an interferometer as a ground truth, a result of a scan using the scanner described herein, and a benchmark three-dimensional scanner result, respectively in accordance with various embodiments of the present disclosure.

FIG. 14 shows curvature visualization results, from left to right, for an interferometer as a ground truth, the scanner described herein, and a benchmark scanner on mean curvature feature with kernel radius of 0.1 mm and close-up surface information in accordance with various embodiments of the present disclosure.

FIG. 15 shows locations of four selected square regions for an M3C2 method comparison in accordance with various embodiments of the present disclosure.

FIG. 16 includes a top row showing different results between the scanner described herein and an interferometer, and a bottom row showing differing results between the benchmark scanner and the interferometer at each selected square region shown in FIG. 15.

FIG. 17 shows a location of four sets of randomly selected sub-regions for aerial parameter calculation in accordance with various embodiments of the present disclosure.

FIG. 18 shows results of aerial parameter correlation with interferometer measurements for both the scanner described herein and benchmark scanners at four different square regions.

FIG. 19 shows a calibration target formed of a soda-lime glass substrate and calibration pattern deposited thereon using a metal chrome in accordance with various embodiments of the present disclosure.

FIG. 20 shows an example of a reconstruction of a three-dimensional scan performed using the structured light three-dimensional scanner as described herein in accordance with various embodiments of the present disclosure.

### DETAILED DESCRIPTION

The present disclosure relates to a structured light three-dimensional scanner having high spatial resolution, as well as applications thereof. For instance, applications of the structured light three-dimensional scanner may include additive manufacturing (AM) quality assurance applications, three-dimensional printing applications, and the like.

In advanced manufacturing, quality control is ideally automated to improve error detection rates and reduce labor in having an individual analyze a manufactured object. To this end, quality control systems are utilized to detect and mitigate defects based on sensor technologies. Additive manufacturing, also referred to as three-dimensional printing, is used currently to fabricate parts through a layer-wise addition of material. However, the sustainability of AM is constrained by inherent limitations of layer-by-layer fabrication, leading to numerous defects such as balling, porosity, and distortion.

Accordingly, it can be beneficial to perform “online” or network-based layer-wise monitoring as defects that occur during manufacturing and printing may severely deteriorate product quality. The three-dimensional surface topological information for a layer usually includes critical quality information, such as melt pool size, surface roughness, pores, other defects or unexpected process alterations, etc. For example, melt pool size directly correlates with penetration depth, residual stress, and overall geometry precision.

Three-dimensional surface topological information can be obtained, for example, through three-dimensional imaging and scanning, which is a group of sensor techniques that subvert traditional point-to-point measurement. Three-dimensional surface topological information can include three-dimensional point cloud data that evaluate geometrical and dimensional qualities of a manufactured part or object. These techniques can be applied to various industries, such as construction, entertainment, and medical instruments. However, their use for online process monitoring and control in advanced manufacturing is limited, generally due to insufficient spatial resolutions and slow scan speeds of existing scanning technologies.

In a first aspect, a method for scanning an object is described that includes providing a structured light three-dimensional scanner (SLS) comprising: a first imaging device having a first lens, a second imaging device having a second lens, and a controller. The first imaging device and the second imaging device may collectively have a field-of-view less than or equal to 50×50 mm. The method further includes capturing, by the first imaging device and the second imaging device, calibration images of a calibration target having a predetermined pattern thereon: calibrating, by the controller, the structured light three-dimensional scanner using the calibration images; capturing, by the first imaging device and the second imaging device, images of the object to be scanned; and performing, by the controller, triangulation based on the images captured of the object to generate three-dimensional data of the object. The three-dimensional data may have a spatial resolution of 2 to 50 μm.

The structured light three-dimensional scanner may further include a projector. Accordingly, the method may further include directing, by the controller, the projector to project the predetermined pattern onto the calibration target, and capturing, by the first imaging device and the second imaging device, the calibration images of the calibration target as the predetermined pattern is projected on the calibration target by the projector.

In some aspects, capturing the calibration images of the calibration target may further include directing, by the controller, a lighting device to project light parallel to the calibration target. The lighting device may include a polarizer configured to enhance beam parallelism. Capturing the calibration images of the calibration target may include directing, by the controller, the projector to project light on the calibration target, and directing, by the controller, a lighting device separate from the projector to project light parallel to the calibration target. Further, capturing the calibration images of the calibration target may further include adjusting an exposure time of at least one of the first imaging device and the second imaging device to perform overexposure while capturing the calibration images.

In some aspects, the calibration target is a substrate having the predetermined pattern formed thereon, and wherein the predetermined pattern is a checkerboard pattern. The substrate is a ceramic and/or transparent substrate (e.g., a soda-lime glass substrate) and the predetermined pattern may be formed of a metallic material (e.g., chrome) through physical vapor deposition (PVD). In some embodiments, the calibration target is approximately 4.5×6.0 mm to 15×20 mm (e.g., ±5%). The method may further include generating the three-dimensional data of the object during an additive manufacturing or three-dimensional printing process in which another object separate from the object being scanned is formed.

In a second aspect, a system for scanning an object is described that includes a structured light three-dimensional scanner (SLS) comprising: a first imaging device having a first lens, a second imaging device having a second lens, and a controller. The first imaging device and the second imaging device may collectively have a field-of-view less than or equal to 50×50 mm. The controller is configured to: direct the first imaging device and the second imaging device to capture calibration images of a calibration target, the calibration target having a predetermined pattern thereon; calibrate the structured light three-dimensional scanner using the calibration images; direct the first imaging device and the second imaging device to capture images of the object to be scanned; and perform triangulation based on the images captured of the object to generate three-dimensional data of the object. The three-dimensional data may have a spatial resolution of 2 to 50 μm.

In some aspects, the structured light three-dimensional scanner includes a projector, and the controller is further configured to direct the projector to project the predetermined pattern onto the calibration target, and direct the first imaging device and the second imaging device to capture the calibration images of the calibration target as the predetermined pattern is projected on the calibration target by the projector. The controller may be further configured to direct a lighting device to project light parallel to the calibration target, and direct the first imaging device and the second imaging device to capture the calibration images of the calibration target as the lighting device projects the light parallel to the calibration target. The lighting device may include a polarizer configured to enhance beam parallelism.

The controller may be further configured to: direct the projector to project light on the calibration target, and direct a lighting device separate from the projector to project light parallel to the calibration target as the calibration images are captured by the first imaging device and the second imaging device. The controller may be further configured to adjust an exposure time of at least one of the first imaging device and the second imaging device to perform overexposure as the calibration images are captured by the first imaging device and the second imaging device.

In some aspects, the calibration target is a substrate having the predetermined pattern formed thereon, and wherein the predetermined pattern is a checkerboard pattern. For instance, the substrate may be a ceramic and/or transparent substrate (e.g., soda-lime glass substrate) and the predetermined pattern is formed of a metallic material through physical vapor deposition (PVD).

In various aspects, the system further includes an additive manufacturing device (e.g., a three-dimensional printer), where the controller is configured to generate the three-dimensional data of the object during an additive manufacturing process in which another object separate from the object being scanned is formed by the additive manufacturing device and communicate the three-dimensional data to the additive manufacturing device as the other object is formed.

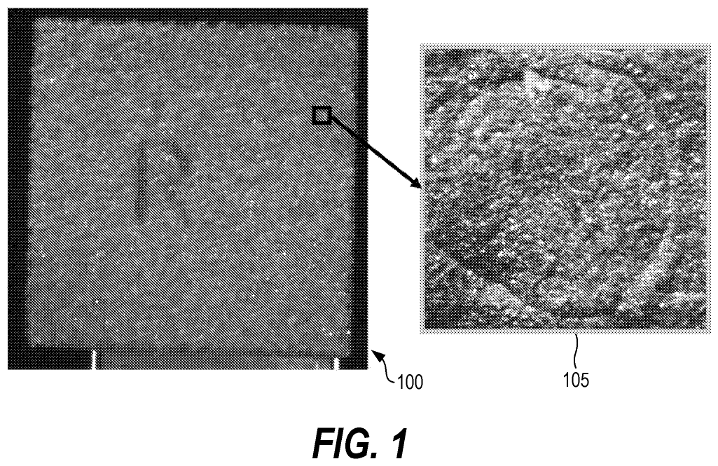

Turning now to the drawings, FIG. 1 shows a high-resolution image of a metal additive manufacturing object 100 that was surface printed using a metal allow. Callout region 105 is a microscopic view of a solidified melt pool of the metal additive manufacturing object 100, which is generally recognized as an undesirable defect. Callout region 105 shows that the solidified melt pool can be identified as having surrounding wrinkles, which have around 20 μm width. To accurately locate and describe these wrinkles, three-dimensional scan data with a spatial resolution of 5 μm or higher is needed, which is difficult to achieve under stringent scanning speeds

As additive manufacturing involves many layers of printing, a scanning speed of a scanning device should be within a scale of several seconds in order to make the scanning device feasible for network-based, online, and/or real-time process monitoring. Among various types of three-dimensional scanning techniques, the present disclosure relates to a structured light three-dimensional scanner (SLS) having an adjustable field-of-view (FOV), fast scanning functionality, and a relatively simple structure, which may reduce manufacturing costs and complexity. Moreover, the present disclosure provided a structured light three-dimensional scanner capable of reaching 2-5 μm spatial resolution requirements.

Due to fast scanning times, the structured light three-dimensional scanner (SLS) described herein may be implemented for in-process and real-time monitoring processes for metal additive manufacturing, polymer additive manufacturing, and so forth. In accordance with some embodiments, the structured light three-dimensional scanner has a 2-5 μm spatial resolution, a second-level scanning speed, is manufacturable at a low cost, and has a compact size.

In some implementations, the structured light three-dimensional scanner described herein may be implemented to scan critical local regions of an part having stringent quality requirements, and thus high spatial resolution scan data is generated to analyze surface topological features including, but not limited to, the wrinkle features shown in the callout region 105 of FIG. 1. The structured light three-dimensional scanner may thus fill the gap in micron-level resolution scanning and can be implemented in various technological areas, such as bio-medical scanning (e.g., bone tissue scanning), in-process quality control in precision instrument manufacturing (e.g.,, dental devices, watches, and gas turbine blades manufacturing). and online process monitoring of additive manufacturing.

Triangulation uses three measurement points to determine a surface geometry. Instead of projecting a dot or a line as in triangulation, the structured light three-dimensional scanner described herein can utilize a projector, in some embodiments, to project one or more fringe patterns onto a surface of an object to be measured. For a single scan, which takes seconds, the structured light three-dimensional scanner can capture an entire projected area, thereby enabling rapid data collection and analysis as compared with other scanning methods. The covered area can be adjusted by refocusing an imaging device (e.g., a camera) and a projector to a desired field-of-view (FOV). However, due to hardware size and shape limitations, the field-of-view can be limited to tens of centimeters, and the resulting spatial resolution can be limited to the sub-mm level. A smaller field-of-view will yield a higher spatial resolution, but creates new challenges in system design and calibration.

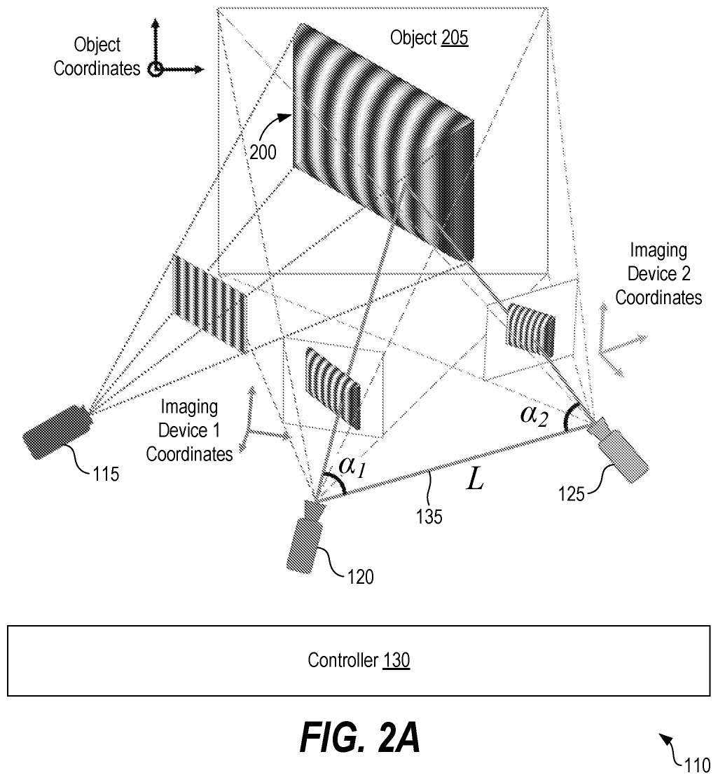

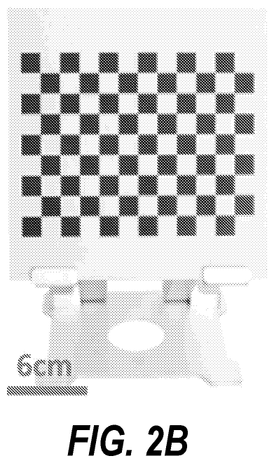

Moving along to FIG. 2A, a dual-camera structured light three-dimensional scanner 110 is described that, in various embodiments, includes a projector 115, a first imaging device 120, and a second imaging device 125. The first imaging device 120 and/or the second imaging device 125 may include digital cameras and like devices. As illustrated in FIG. 2A, the projector 115 may be configured to project a predetermined pattern, such as a sinusoidal black and white fringe pattern shown in FIG. 2, on a target surface 200. The target surface 200 may include a surface of an object 205 to be scanned, a calibration object, and so forth. The fringe pattern, which may be one or more or a set of fringe patterns, will be distorted on the target surface 200 due to variations in surface height, which can be precisely captured by the imaging devices 120, 125. The structured light three-dimensional scanner 110 can further include a controller 130 in data communication with the projector 115 and the imaging devices 120, 125. In some embodiments, the projector 115 can be equipped with a lens that reduces a projected field of view to be equal to or less than 50×50 mm. As will be described, the projector 115 may project a pattern during measurement. For instance, the projector 115 may project one or more fringe patterns (e.g., a sinusoidal fringe pattern) for measuring an object 205.

The first imaging device 120 and the second imaging device 125 may collectively have a field-of-view less than or equal to 50×50 mm in some embodiments. Further, the three-dimensional data may have a spatial resolution of 2 to 50 μm in some implementations (e.g., 2, 5, 10, 20, 30, 40, and 50 μm). The controller 130 may include circuitry or a general purpose computing device (as described below) that may be communicatively coupled to the projector 115, the imaging devices 120, 125, additional lighting devices (not shown), and so forth, and may generate suitable signals to direct or otherwise oversee operation of these components. For instance, the controller 130) may be configured to direct the first imaging device 120 and the second imaging device 125 to capture calibration images of a calibration target having a predetermined pattern thereon, calibrate the structured light three-dimensional scanner 110 using the calibration images, direct the first imaging device 120 and the second imaging device 125 to capture images of an object 205 to be scanned, and perform triangulation based on the images captured of the object to generate three-dimensional data of the object 205.

To this end, the controller 130 may execute or otherwise implement (e.g., via circuitry) a triangulation routine to calculate a relative position of measuring points and center of a scanning system. A triangle 135 is thus formed by a point of interest on the object 205 and the two imaging devices 120, 125. The triangle geometry can be determined as a function of a distance L between imaging devices 120, 125, and the angles α₁ and α₂ formed by the line connecting the two imaging devices 120, 125 and the lines connecting each imaging device 120, 125 to the measurement point. The aforementioned angle and distance information can be acquired during the calibration process in some implementations. For instance, a spatial relationship between the two imaging devices 120, 125 may be determined calculated from twenty to thirty pairs of images (or other number of images) of a calibration target 300, taken at different angles and positions.

While shown in FIG. 2A, in some implementations, the projector 115 is not included as a calibration target 300 having a predetermined pattern etched thereon may be employed in lieu of a projection of the predetermined pattern, as will be described. However, FIG. 2B depicts a non-limiting example of a calibration target 300. The calibration target 300 may include a flat surface that contains a black and white checkerboard pattern, although other predetermined patterns may be employed. The positions where the black squares intersect can be referred to as reference points. By comparing locations of these reference points on an image taken by different imaging devices 120, 125, translational and rotational information between their coordinates can be determined. Due to lens imperfections, the images can include varying levels of distortion in the measuring space. By analyzing the reference points within each image, the lens distortion can be calibrated and compensated in the measurement. Thus, the quality of the image of the calibration target 300 is a notable factor that affects an accuracy of the calibration. The image quality can be influenced by both the calibration target 300 and the image capturing process.

A key challenge in improving spatial resolution includes system design and calibration of a small field-of-view, such as, but not limited to, a field-of-view at or below 50×50 mm. The system design requires a balance of the specification of hardware components (e.g., imaging devices 120, 125, lenses thereof, and the projector 115). As such, a tradeoff exists between coverage area and spatial resolution. A calibration procedure can focus on the quality and size of the patterns in the calibration target 300, in addition to noisy image-taking environments that may result from non-ideal lighting.

Generally, an accuracy of a structured light three-dimensional scanner can be determined by a root mean square error (RMSE) and a standard deviation (σ) of the measurement on a flat surface and a fitted plane based on that measurement. However, the color and finish of the standard target might differ from the surface in the application. Additionally, the errors are assessed by comparing with the fitted plane, which is different from the ground truth surface. The spatial resolution (5 μm) is used as the initial constraint for the hardware selection, and it is determined by both the spatial resolutions of the cameras and the projector as follows,

$${SR}_{SLS} = Min ( {SR}_{Camera} , {SR}_{Projector} ) \qquad ( 1 )$$

where SR represents spatial resolution.

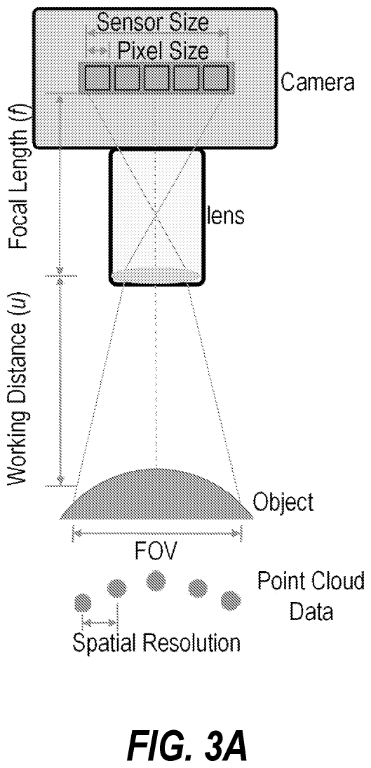

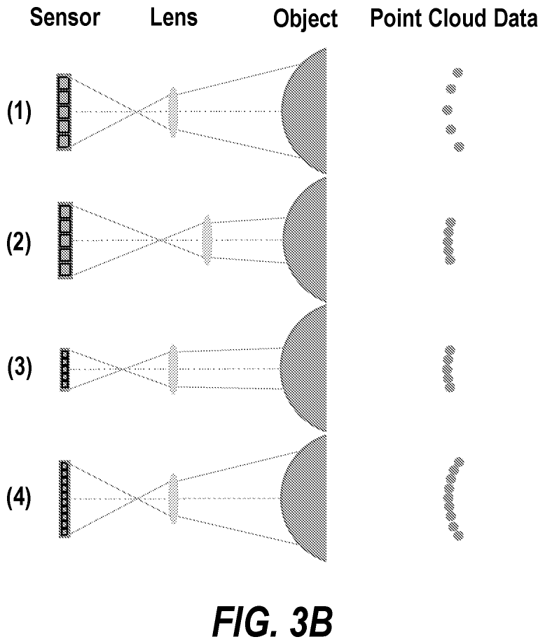

Turning now to FIG. 3A, FIG. 3A shows an example imaging device capturing images due to a lens passing light reflected from a targeting object onto an internal image sensor. Specifically, FIG. 3A illustrates the relationship among a field-of-view, a working distance (u), a focal length (f), a pixel size, a sensor size and a spatial resolution. The image sensor includes an array of photosensors, each of which produces a pixel in the resulting image. The total number of photosensors is generally referred to as pixel resolution, and the physical dimension of each photosensor is generally referred to as pixel size. These are the two specifications of an image sensor, and they directly determine the sensor size as follows.

$$Sensor Size = Pixel Size \times Pixel Resolution \qquad ( 2 )$$

The camera spatial resolution is the physical distance between two adjacent pixels in the image. The smaller the distance, the higher the camera spatial resolution. The spatial resolution can be determined by both the internal image sensor and the camera lens as follows,

$${SR}_{Camera} = \frac{{FOV}_{Camera}}{Pixel Resolution} \qquad ( 3 )$$

$${FOV}_{Camera} = \frac{Sensor Size \times u}{f} [ 24 ] \qquad ( 4 )$$

where SR_{Camera} is the spatial resolution of an imaging device; FOV_{Camera} is the field-of-view of the imaging device (e.g., the area the imaging device can cover under the working distance), u is the working distance of the camera (the distance between lens and object), and f is the focal length of the lens (the distance between the lens and the sensor). Illustrations of these terms are shown in FIG. 3A.

Referring next to FIG. 3B, FIG. 3B illustrates various methods for improving spatial resolution. First, spatial resolution can be improved in an original setting before any adjustment. Second, the field-of-view can be reduced, where spatial resolution is improved but coverage area is reduced. Third, pixel size can be reduced, whereby spatial resolution is improved, but coverage area is reduced. Fourth, the pixel size can be reduced and the pixel resolution can be improved, where spatial resolution is improved without sacrifice coverage area.

Based on Eqs. (1)-(4) above, it can be seen that the pixel size and pixel resolution are proportional to camera spatial resolution, and the focal length is inversely proportional to the camera spatial resolution. If the focal length of the camera lens is increased, then the field-of-view will be smaller, and consequently, the spatial resolution will be improved, as shown in the second row of FIG. 3B. If the sensor pixel size is reduced, then the field-of-view will be smaller and, consequently, the spatial resolution will be improved, as shown in the third row of FIG. 3B. If the sensor resolution is increased, then the cameral spatial resolution can be improved directly, as shown in the fourth row of FIG. 3B.

The projector 115 shares a principle with the imaging devices 120, 125 in terms of spatial resolution. The two limiting features are the lens and micro-display. Here, the micro-display is analogous to the sensor in the imaging device, but is used to project the image onto the object 205. In general, the resolution of a projector micro-display (1280×720 pixels) is much lower than that of a camera sensor (3000×4000 pixels). Therefore. the projector 115 is generally considered as the bottleneck for improving the structured light three-dimensional scanner spatial resolution.

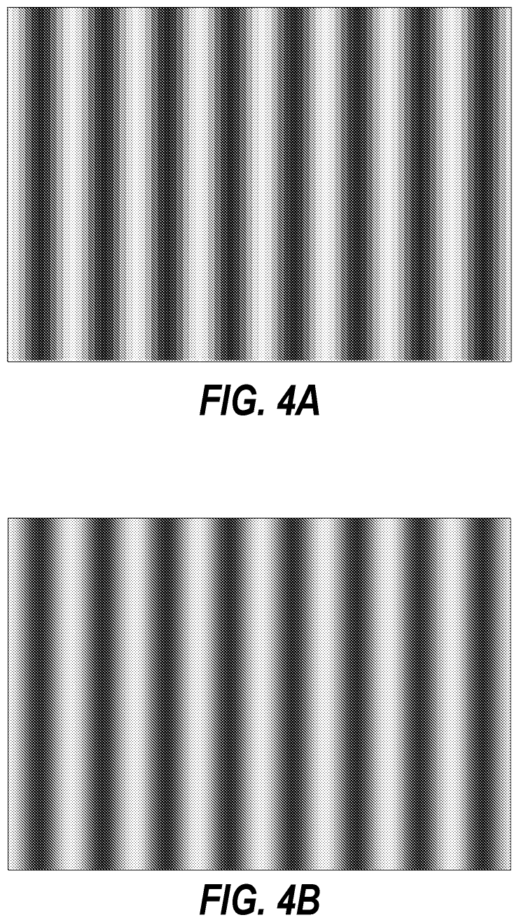

However, this issue can addressed through software and various implementation techniques such that the resolution of the projector 115 will not affect that of the structured light three-dimensional scanner and system thereof. Specifically, phase-shifting routines and defocusing routines may be implemented to account for a resolution of the projector 115. Instead of a single image projection, the phase-shifting routine projects multiple patterns (e.g., six patterns) with equally divided 2π/6 phase shifts. The combination of these six grayscale readings are employed by the controller 130 to distinguish adjacent points. Second, the defocusing routine can remove grayscale discontinuity, as shown in a comparison between FIGS. 4A and 4B. Thus, the spatial resolution of the structured light three-dimensional scanner is not affected by the projector 115 but determined by the imaging device 120, 125 only so long as the projector 115 can focus on a similar field-of-view with the imaging devices 120, 125. Correspondingly, Eq. (1) can be simplified as Eq. (5).

$${SR}_{SLS} \approx {SR}_{Camera} \qquad ( 5 )$$

Referring back to FIG. 1, as shown, in additive process monitoring, some small areas (e.g., 15×15 mm²) can be covered by the field-of-view of the structured light three-dimensional scanner 110. According to Eq. 3, the pixel resolution of the imaging device 120, 125 needs to be at least 3000×3000 to satisfy a desired spatial resolution requirement (e.g., 2 μm, 3 μm, 4 μm, or 5 μm), which can be a starting point for imaging device and lens selection. A dual-camera structured light three-dimensional scanner may include two imaging devices 120, 125, two lenses thereof, and a projector 115.

An optimal structured light three-dimensional scanner camera, for example, for use in metal additive manufacturing in-situ monitoring, can have a compact size, high frame rate, high pixel resolution, low noise, and small pixel size. As pixel resolution is set by a desired spatial resolution requirement as previously discussed, selection can be based on sensor pixel size. A smaller pixel size can improve the spatial resolution, given all other criteria are fixed. However, if the pixel size is too small, a noise level will be high. In some implementations, a sensor with a 3.45 μm pixel size can be employed as it can capture melt pool details during the online monitoring without sacrificing imaging quality. However, in other implementations, other sensor sizes can be employed.

To fit imaging devices 120, 125 in a small field-of-view configuration required for metal additive manufacturing, a machine vision camera can be selected to have a compact size and a high pixel resolution (e.g., 3000×4000), which can ensure a large coverage area without sacrificing spatial resolution, and a frame rate thereof is 30 Hz. The resulting field-of-view is 15×20 mm² due to the aspect ratio of the sensor. The resulting field-of-view results in a spatial resolution of 5 μm, or other desired spatial resolution.

To avoid the damage caused by heat from the metal additive manufacturing part surface, a relatively long working distance (u>80 mm) can be maintained. According to Eqs. (3) and (4), given the pixel size (e.g., 3.45 μm), the pixel resolution (3000×4000). the working distance (80 mm), and the field-of-view (15×20 mm²), the focal length f should be at least 54 mm. Moreover, the lens should have an appropriate resolving power, which is the minimal distance between two lines or points that can be distinguished by the lens. Resolving power can be determined by the optical polishing quality of the lens.

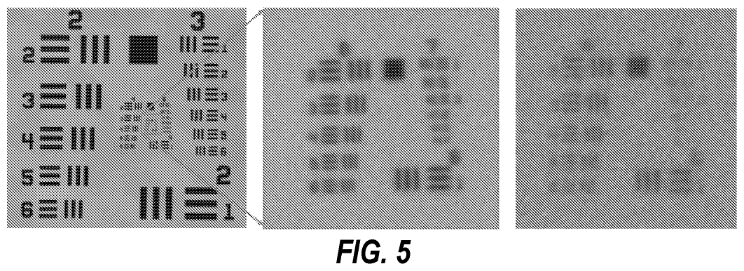

The resolving powers of eight different lenses over 55 mm focal lengths f were determined using a 1951 USAF Resolving Power Test Target, as shown in the left-most column in FIG. 5. The conversion between the group & element number and resolving power can be acquired using a predetermined table. The lenses are all set to 65 mm focal lengths f, FIGS. 5B and 5C show an example of a comparison between high and low resolving power lenses. A 55-75 mm zoom semi-telocentric lens was selected as it has the highest resolving power. This level of resolving power is very close to the determined sensor size of 3.45 μm. Therefore, it does not have a substantial influence on the spatial resolution of the overall system.

With respect to the projector 115, a projector 115 with a suitably small micro-display (AAXA P2) was selected due to its compact size. The projector 115 may thus have a 1280×720 pixel resolution, and the lens may be modified with an additional condenser lens to shift the projection area from 15×20 cm² to 18×24 mm², which is similar to the desired field-of-view. Even though the projector 115 has a lower spatial resolution than the selected imaging devices 120, 125, the lower spatial resolution will not affect the spatial resolution of the structured light three-dimensional scanner 110 as the phase-shifting routines and the defocusing routines can be implemented.

Commonly used calibration targets 300 are slightly smaller than the expected field-of-view (e.g., 300×400 mm² to 600×800 mm²). However, the desired field-of-view in various embodiments of the present disclosure is quite small (15×20 mm²). Therefore, there is no commercial calibration target 300 available to fulfill the needs. Additionally, the surface quality of regular substrate material, such as paper or plastic, is inadequate for high precision calibration targets 300. The checkerboard pattern on the target, such as that shown in FIG. 2B, is typically made using either an inkjet or a laser printer, and the resulting print quality is normally up to 1200 dots per inch (DPI), which is equivalent to 21 μm between two adjacent dots. This level of spatial resolution is significantly lower than various embodiments of the structured light three-dimensional scanner 110 described herein, such as a 5 μm spatial resolution.

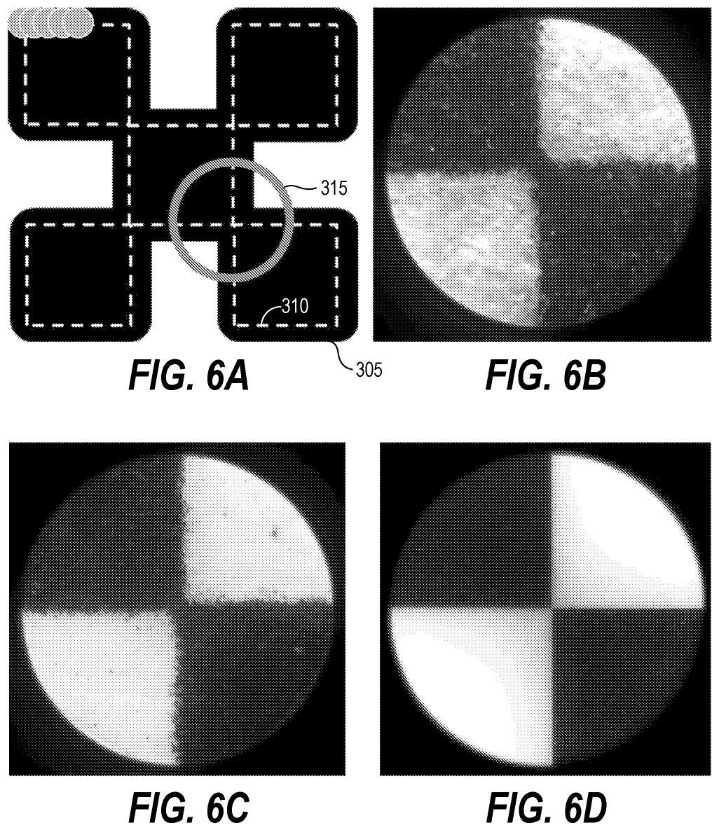

As shown in FIG. 6A, the shape printed consists of many small ink drops (represented by the grey circles in the top left). When the DPI of a printer is low, the ink drops are large. This leads to the printed region 305 being larger than the designed shape 310, and consequently, the reference points will be very difficult or even impossible to identify. As for the substrate, fine surface paper or matte surface plastics are commonly used materials. However, neither is smooth enough to prevent undesired reflections. The relatively rough surface will cause misalignment of the reference points, and the reflection nonuniformity will cause image noise. These two issues can adversely affect the accuracy of calibrations.

FIGS. 6B-6D collectively show a microscopic partial view on circular region 315 of a calibration target 300 made by a fine paper and 1200 dpi printer. shown in FIG. 6B, a 4000 grit polished plastic and 1200 dpi printer, shown in FIG. 6C, and a chemically treated ceramic and physical vapor deposition (VPD), shown in FIG. 6D.

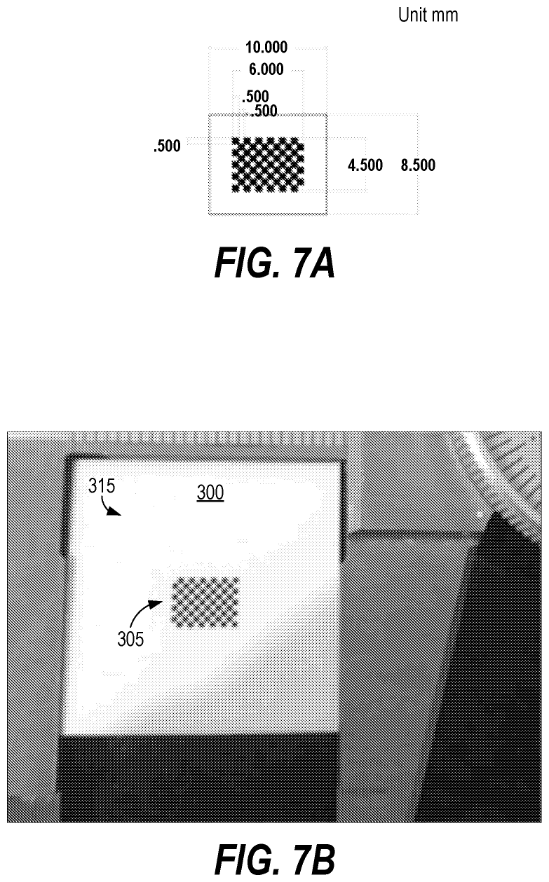

According to various embodiments, a calibration target 300 includes a pattern that can fit in the small field-of-view (e.g., 15×20 mm²) needed for online monitoring of EBM, such as the pattern shown in FIG. 7A with example dimensions shown for explanatory purposes only. Referring back to the circular region 315 shown in FIG. 6A, microscopic views of the circular region 315 of FIG. 6A are shown in FIGS. 6B-6D, respectively, which correspond to different substrate materials and pattern printing methods. As, such a predetermined pattern 305 (e.g., the pattern shown in FIG. 6D) can be printed using physical vapor deposition or like technology with a metal chrome material on a ceramic substrate 315 or like material substrate. As compared to the patterns in FIGS. 6B and 6C, it is clear that the target shown in FIG. 6D has the most uniform surface and sharpest reference point intersections at this measuring scale. In various embodiments, a surface of the ceramic substrate 315 can be chemically treated to provide a matte opaque finish with 0.4-0.7 μm surface roughness (Ra). A final calibration target 300 having the predetermined pattern 305 corresponding to that of the embodiment of FIG. 6D is shown in FIG. 7B.

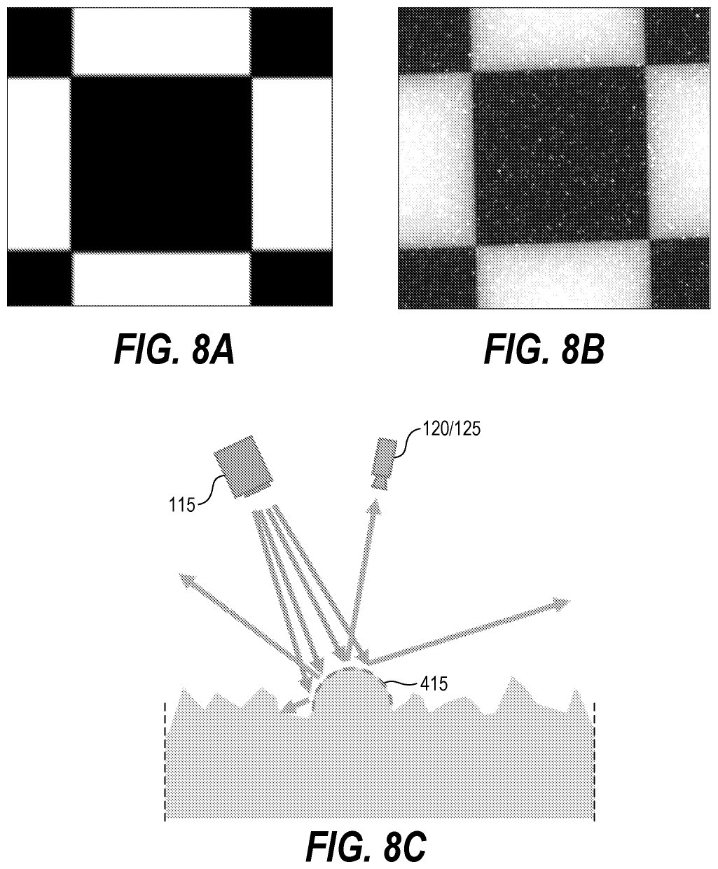

From FIG. 6D, it is clear that the calibration target 300 shown therein has a smoother surface. However, a smooth surface does not necessarily ensure a successful calibration for a desired field-of-view. An ideal calibration image should have high contrast in black and white regions and be free of noise, as shown in FIG. 8A. However, the current calibration image has a very high noise level, as shown in FIG. 8B, which will result in lower accuracy or even failure in calibration. Notably, there are two types of imperfections in the calibration image of FIG. 8B. First, numerous bright spots exist in both white and black regions. Second, there is a brightness variation in the white and black boundaries. Therefore, in accordance with various embodiments, one or more noise reduction techniques for calibration image processing can be implemented.

Noise reduction using an external parallel light source. The first type of imperfection described above can be caused by imperfect lighting source during the calibration. In various embodiments, to help with an image-taking process, the calibration target 300 can be illuminated, which is typically done by the projector 115. However, this approach cannot be implemented, in some scenarios, to a small area (e.g., 15×20 mm²) calibration. For instance, tiny spherical areas 415 on a matte calibration target surface, shown in FIG. 8C, reflect illumination light and create bright spots. To avoid this, light beams from a light source can be positioned parallel to each other, and the direction of these beams can be set as parallel to the target surface as possible. As the projector 115 is a point light source, a separate parallel light source (not shown) can be used in various embodiments. Unlike the projector 115, which is pointed perpendicular to the calibration target 300, the parallel light source is pointed substantially parallel to the calibration target 300 (e.g., ±10%).

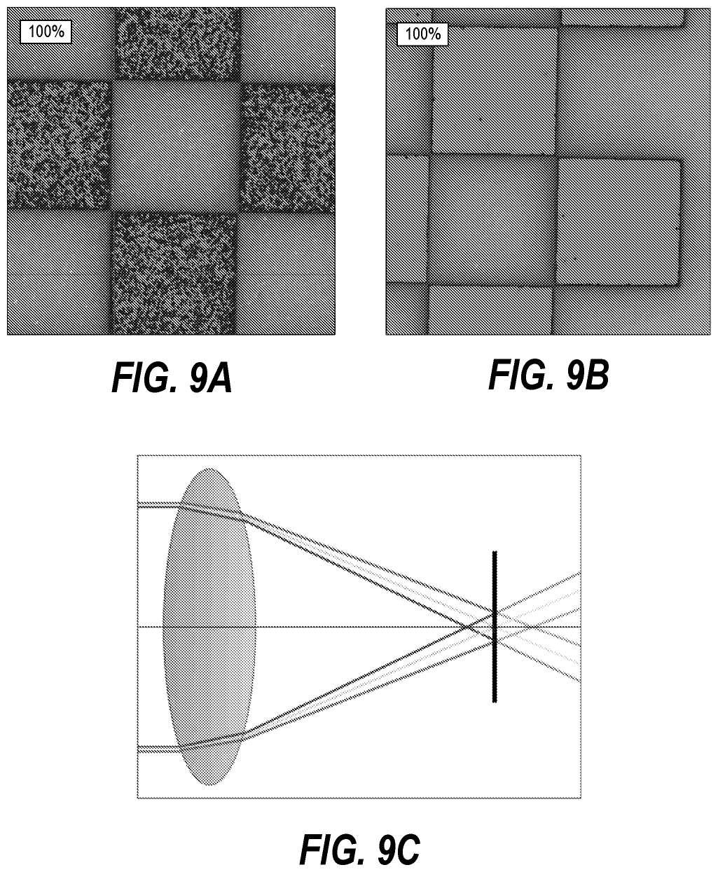

Additionally, in various embodiments, a polarizer (not shown) can be added to the light source to enhance its beam parallelism. Compared to that of FIG. 8B, FIG. 9A shows the reduced intensity of bright spots after changing the pointing direction of the light source from perpendicular to near-parallel, and FIG. 9B illustrates a reduced number of bright spots after enhancing the beam parallelism by adjusting the polarizer.

Noise reduction by overexposure. Another type of imperfection of the calibration image can be caused by axial chromatic aberration. Axial chromatic aberration can include a lens not being able to focus on different colors present on the same plane, as shown in FIG. 9C. Axial chromatic aberration is a typical problem for long focal length (e.g., f>50 mm) lenses which are required by small field-of-view (e.g., 15×20 mm²) focus. As the structured light three-dimensional scanner described herein, in some implementations, may require monochrome images, color information can be disregarded, and the aberration effect can be reduced by overexposing the white region.

Traditionally, existing calibration methods require exposure of both the black and white regions within the dynamic range of an imaging device. In general, either overexposure or underexposure needs to be avoided. However, with properly controlled overexposure, the axial chromatic aberration can be significantly reduced, which will result in very sharp contrast calibration images. According to various embodiments, overexposure can be achieved by properly adjusting the exposure time. The exposure time is determined by the time at which all the white regions are overexposed while the black regions are not.

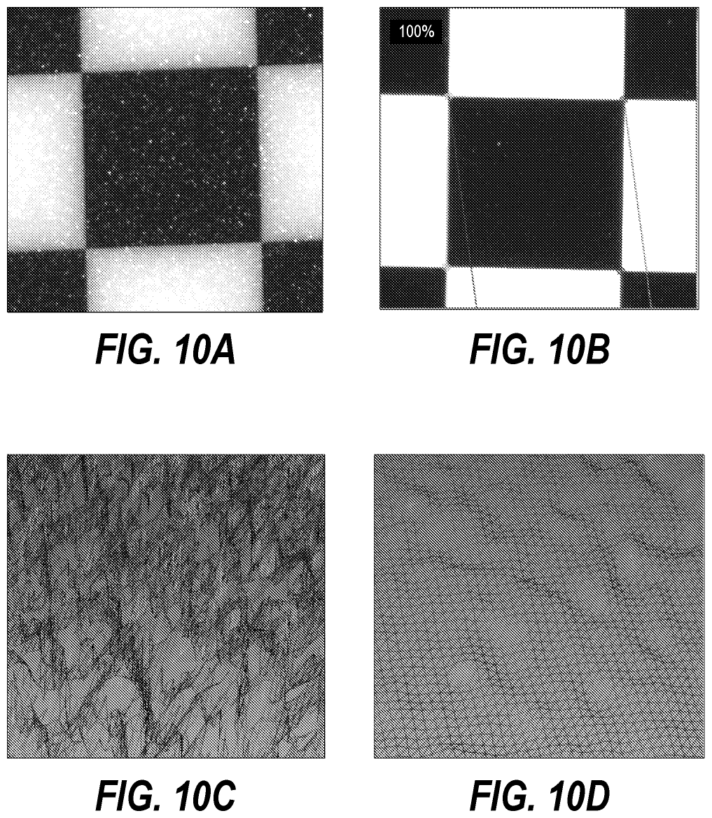

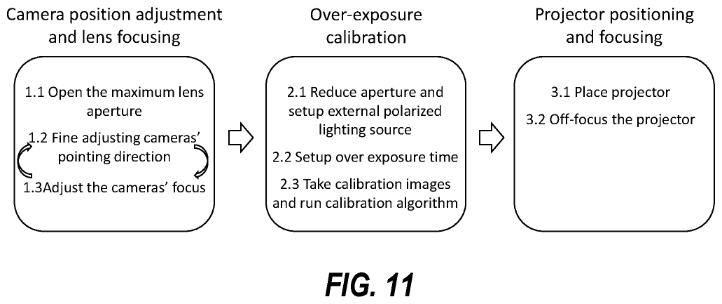

An example of the resulting calibration image after applying the two noise reduction methods described above is shown in FIG. 10B, in which the two types of calibration imperfections have been removed significantly when compared to that of FIG. 10A. The scanning results of a flat surface before and after applying the calibration noise reduction are shown in FIGS. 10C and 10D, respectively. By comparing these two images, it can be seen that a significant scanning accuracy improvement has been achieved.

Calibration Procedure. According to various embodiments, for calibration of a small area or field-of-view (e.g., 15×20 mm²), a special calibration procedure may be implemented, which includes all or a subset of the noise reduction methods described above. Generally, in some embodiments, a calibration procedure may include camera position adjustment and lens focusing; over-exposure calibration: projector positioning and focusing, as will be described, with reference to FIG. 11.

Camera Position Adjustment and Lens Focusing. The two imaging devices 120, 125 can be positioned from the calibration target 300 such that the imaging devices are at a desired working distance (calculated by Eq. 4, e.g., u=80 mm) from a sample. Next, an angle (e.g., at least a 10° angle which is the minimum angle required by structured light three-dimensional scanner triangulation calculation) can be established between the two imaging devices 120, 125. A larger angle may cause problems in calibration due to left and right sides of the image from each imaging device 120, 125 being out of focus. Thereafter, the camera aperture can be set to a maximum value under ambient room lighting. This may create a shallowest depth of field and may assist in focusing the imaging devices 120, 125. The focuses of cameras are then adjusted until the middle of the calibration target 300 is clear, and both left and right are equally blurred. The fine adjustment of the imaging devices 120, 125 and/or the adjustment of the focus of the imaging devices 120, 125, are repeated until both imaging devices 120, 125 are pointing at a center of the calibration target 300 and properly focused.

Over-exposure calibration. First, the aperture f-number can be set to sixteen or other suitable metric on each lens, which can improve the depth of field for calibration and measurement, which is the smallest aperture that can avoid intensive chromatic aberrations. Then, the lighting source is set up, and the polarizer is adjusted as discussed until both imaging devices 120, 125 receive the dimmest light input. Thereafter, the over-exposure technique is used as discussed to set the proper exposure time. These two methods can significantly reduce the noise in the calibration images. Once the imaging device 120, 125 and lens adjustment are finished, a number of calibration images are captured of the calibration target 300 at different locations and angles. Then, the calibration methodology is executed or otherwise carried out.

Projector Positioning and Focusing. First, the projector 115 can be placed a predetermined distance (e.g., 65 cm which is the shortest focusing distance of the projector 115 after the lens modification described above) away from the sample surface, and the lens of the projector 115 is finely adjusted to focus on the measuring plane. Once the projector 115 is focused, the projector 115 can be moved towards the image device 120, 125 a predetermined distance (e.g., 0.5 mm). This will result in defocus, which improves fringe pattern smoothness.

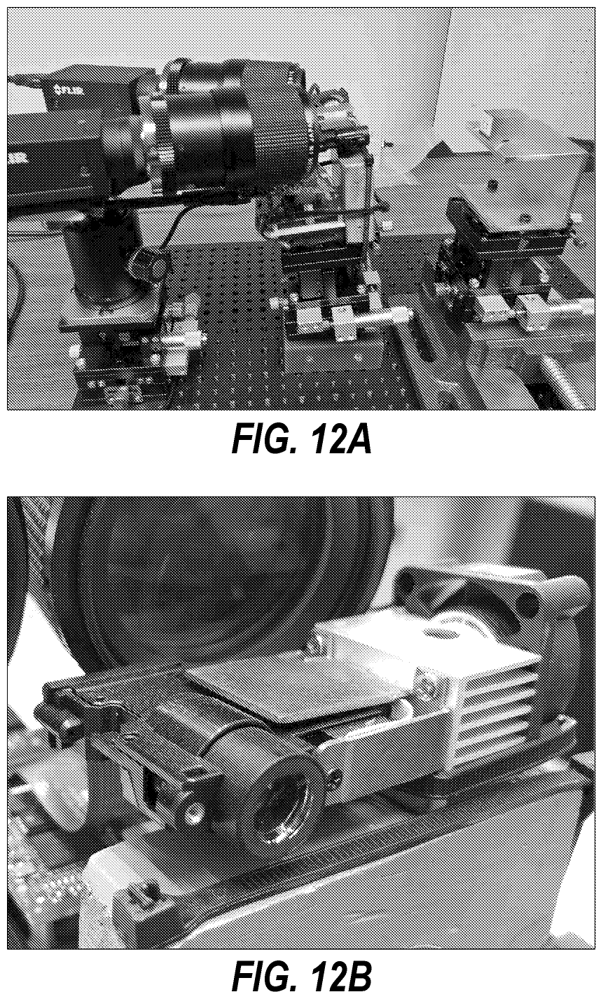

System Integration and Fixture Design. The dual-camera structured light three-dimensional scanner 110 utilizing the techniques described herein was developed, as shown in FIG. 12. The structured light three-dimensional scanner 110 consists of multiple XYZ & RZ stages for fine-tuning the position and direction of each hard component. The two imaging devices 120, 125 are mounted on a slider rail, which gives each imaging device 120, 125 an additional two degrees of freedom in the X and RZ direction. The rail and the stages for the imaging devices 120, 125 are connected by a ball joint to ensure both imaging devices 120, 125 are properly leveled. Each stage has a predetermined travel range (e.g., 10 mm) in the XYZ direction with a predetermined accuracy (e.g., 10 μm). In the RZ direction, the accuracy is 0.01°. The structured light three-dimensional scanner 110 is then calibrated to a 15×20 mm² field-of-view, and the resulting spatial resolution is 5 μm, which is determined by Eqs. (3) and (5), given the camera pixel resolution is 3000×4000 pixels.

Qualitative and quantitative accuracy validation. An example object, such as the Ti-6Al-4V part manufactured through additive manufacturing shown in FIG. 1, was used as the standard object for measurement. A white light interferometer was used to reconstruct the surface and is treated as ground truth. Then, the scanned result of the structured light three-dimensional scanner 110 described herein was compared with this ground truth for accuracy testing. Together, the accuracy of an existing structured light three-dimensional scanner was used as a benchmark and verified by the same method to justify the high accuracy of the embodiment of the structured light three-dimensional scanner 110 described herein. The performance of both structured light three-dimensional scanner scanners has been both qualitatively and quantitatively compared.

Qualitative visualization and comparison and point cloud visualization. The standard object (e.g., Ti-6Al-4V part) has a 15×10 mm² area and has a letter “R” on the surface to denote the use of a random hatch pattern for fabrication. Such a printing strategy will leave many solidified melt pools, as shown in callout region 105 of FIG. 1.

The result measured by the Zygo New View 8200 white light interferometer is considered the ground truth and shows the highest detail of the surface. The scanning process takes two hours and yields a 1.63 μm spatial resolution result. The scanning is made by a 10X objective lens and 3X CSI mode. The Z-direction searching distance is 300 μm. The entire area is divided into 400 sub-regions, with 4% overlapping.

Point cloud data measured by the structured light three-dimensional scanner 110 described herein can be configured to have 3.5 μm spatial resolution, and the scanning time is four seconds with fifteen seconds to process. The processing includes a triangulation calculation, which transforms raw image data to point clouds (or point cloud data), and mesh translation, which converts discrete point clouds into three-dimensional polygon meshes to build a closed surface. The raw mesh data contains 16,020,264 faces and 8,266,016 vertices. The data set has been applied a smooth filter and the mesh density was reduced to 10% for easier data analytics. Even though the number of meshes is reduced, the melt pool shape can still be well preserved, as shown in FIG. 1.

The benchmark three-dimensional scanner takes a similar scanning and mesh generation time compared with the structured light three-dimensional scanner 110 described herein, but it generates about two-hundred times fewer data points. It is calibrated to the highest manufacturer standard by a 60 mm size calibration target 300 and yields a 47 μm spatial resolution. This spatial resolution is too low to obtain accurate mapping, as illustrated by the poor reconstruction of the letter “R.”

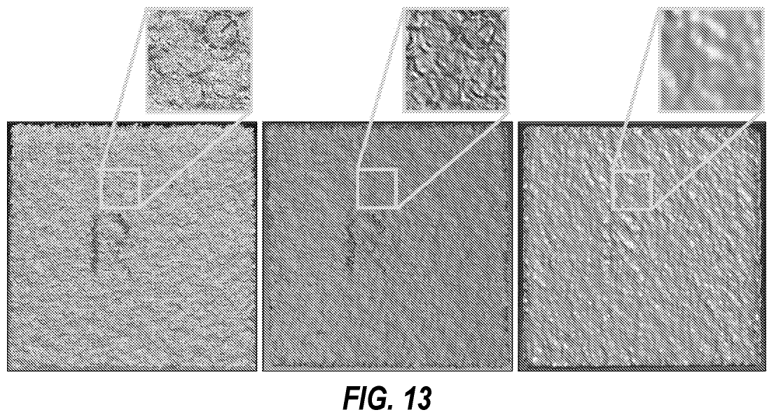

FIG. 13 shows, from left to right, a scan using a ground truth, a result of a scan using the structured light three-dimensional scanner 110 described herein, and a benchmark three-dimensional scanner result, respectively. The enlarged views thereof show that the structured light three-dimensional scanner 110 described herein can clearly capture melt pool geometry as the interferometer does, while the benchmark scanner cannot. An example melt pool was highlighted in both interferometer and proposed scanner zoom-in view with the blue dashes. The scanning result from the interferometer, the structured light three-dimensional scanner 110 described herein, and the benchmark 3D scanner are visualized and shown in FIG. 13 from left to right, respectively. Based on the detailed view of all three results, the structured light three-dimensional scanner 110 described herein can successfully capture the melt pool geometry and the surface letter “R” with minor loss in detail compared to the interferometer. Even though the benchmark 3D scanner is calibrated to the smallest field-of-view, it still cannot clearly show the melt pool geometry, and there is almost no trace of the letter “R” on the surface due to insufficient spatial resolution.

Mean curvature visualization. To further visualize the performance of the different scanning methods, a curvature analysis method is used for the three sets of point cloud data. This method utilizes mean curvature information given a user-defined kernel radius, in powder bed point cloud segmentation. The kernel radius is defined as the radius of a sphere within a neighborhood of points for local distance variation as well as curvature estimation.

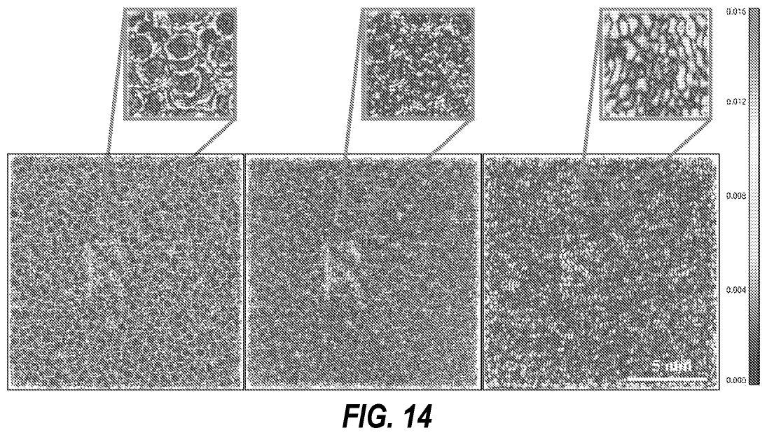

The curvature visualization results of three types of measurement are shown in FIG. 14. The results show that the structured light three-dimensional scanner 110 described herein can clearly capture the circular melt pool geometry while the benchmark only shows random patterns. Additionally, the color distribution that indicates the magnitude of the curvature from the structured light three-dimensional scanner 110 described herein matches well with the interferometry result. This type of surface topography characterization can help establish a relationship between part quality and the processing parameters. The microstructure distribution of the material also has a strong correlation with processing conditions. This gives the potential to correlate the surface topography with the microstructure distribution, and the characterization method as described can contribute to that process. Three-dimensional scanning-based curvature analysis can also easily isolate the region of each melt pool no matter how the local height deviates.

Quantitative Analysis and Comparison. To determine the accuracy, the point cloud data scanned by the structured light three-dimensional scanner 110 described herein and the benchmark scanner are compared to that of the white light interferometry (used as ground truth due to its ultra-high accuracy). The difference in the comparison can represent the measurement error, which is referred to as accuracy. Prior to the comparison, the point cloud data of the structured light three-dimensional scanner 110 described herein and the benchmark scanner are registered into the three-dimensional space of the point cloud data measured by the white light interferometry using an Iterative Closest Point (ICP) routine.

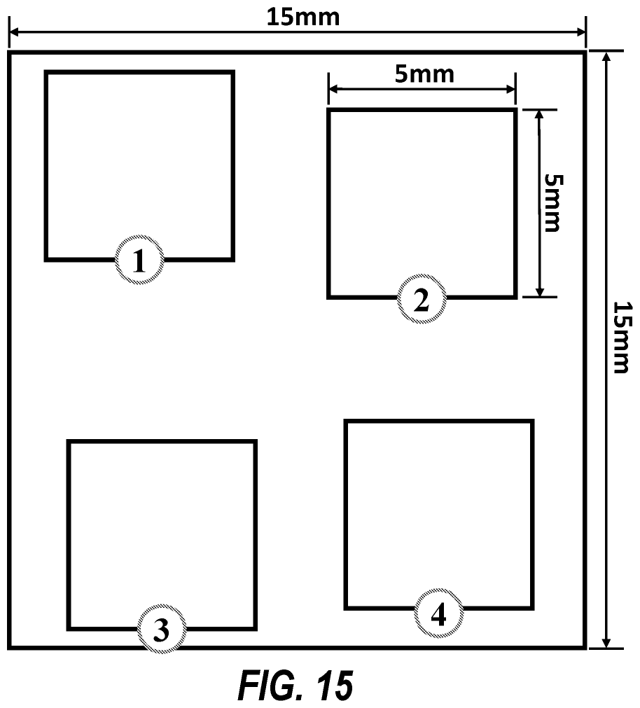

In FIG. 15, four 5×5 mm² square regions are picked for comparison. A point cloud measurement approach may include a multiscale model to model cloud comparison (M3C2), a signed distance computation method with the ability to show confidence intervals on point cloud measurement and registration error. In sum, M3C2 computes the distance between two point clouds along the surface normal direction.

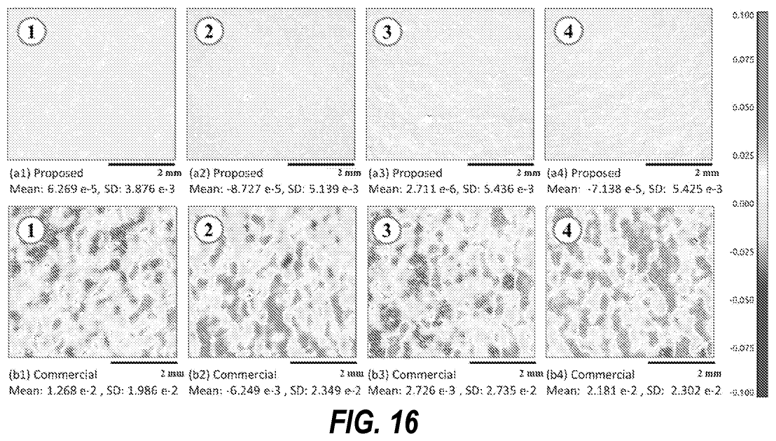

The top row of FIG. 16 shows the difference between the point cloud data sets measured by the structured light three-dimensional scanner 110 described herein and the white light interferometry at each selected region marked in FIG. 15. The bottom row of FIG. 16 shows the difference between the point cloud data sets measured by the benchmark scanner and the white light interferometry. They are both computed by the M3C2 method. The differing results are computed by the M3C2 distance comparison method, and the green color means small errors while blue and red indicate large errors.

As FIG. 16 indicates, the results on the top row are primarily green (or of a lighter color). This means the differences, which correspond to the errors, are small or close to zero. While the results in the bottom row have large portions of red and blue areas (or dark colored areas), indicating higher surface measurement errors inherited from the benchmark scanner. A smaller color variation on the structured light three-dimensional scanner 110 described herein results also demonstrates the consistency of the accuracy on different angle surfaces compared with the benchmark scanner results. The larger surface measurement error on the benchmark system is because of poor spatial resolution as well as systematic noise dominated over measurements. The error of all the points in each region is following the Gaussian distribution. The absolute mean and the standard deviation of them are shown in Table 1. These two statistics can be directly used for accuracy assessment. The four-region averaged absolute mean error of the structured light three-dimensional scanner 110 described herein is 0.056 μm, which greatly outperforms the 10.9 μm error of the benchmark scanner by three magnitudes. As for the four-region averaged standard deviation, the structured light three-dimensional scanner 110 described herein has 4.97 μm, which is significantly smaller than the benchmark scanner's 23.5 μm.

TABLE 1
The absolute mean and standard deviation of the
Gaussian distributed error of the proposed and
benchmark scanner at each square region (unit μm).

| | Disclosed Scanner | | Benchmark Scanner | |
|---|---|---|---|---|
| | Abs. Mean | | Abs. Mean | |
| Location | Error | Std. Dev. | Error | Std. Dev. |
| Sq. 1 | 0.0627 | 3.88 | 12.7 | 19.9 |
| Sq. 2 | 0.0872 | 5.14 | 6.20 | 23.5 |
| Sq. 3 | 0.0027 | 5.44 | 2.70 | 27.4 |
| Sq. 4 | 0.0714 | 5.42 | 21.8 | 23.1 |
| Avg. | 0.056 | 4.97 | 10.9 | 23.5 |

Local Surface Correlation Analysis. In addition to global point cloud comparison, the local surface roughness is another indicator of scanner accuracy. To calculate the surface roughness, aerial parameters can be preferable over profile parameters for surface characterization because the nature of surface metrology is three-dimensional, so the analysis of two-dimensional profiles will provide an incomplete description of the surface. Therefore, the aerial parameter Sa is used in estimating local surface roughness, which defines as the arithmetic mean of the absolute value of the height within a sampling area.

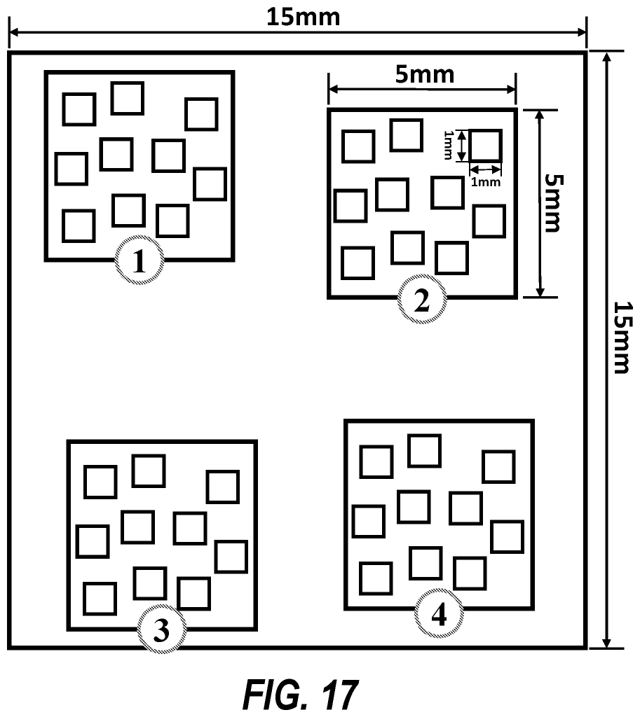

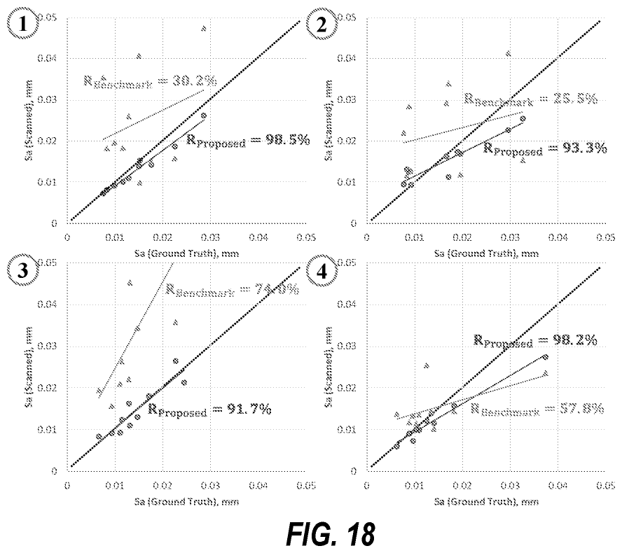

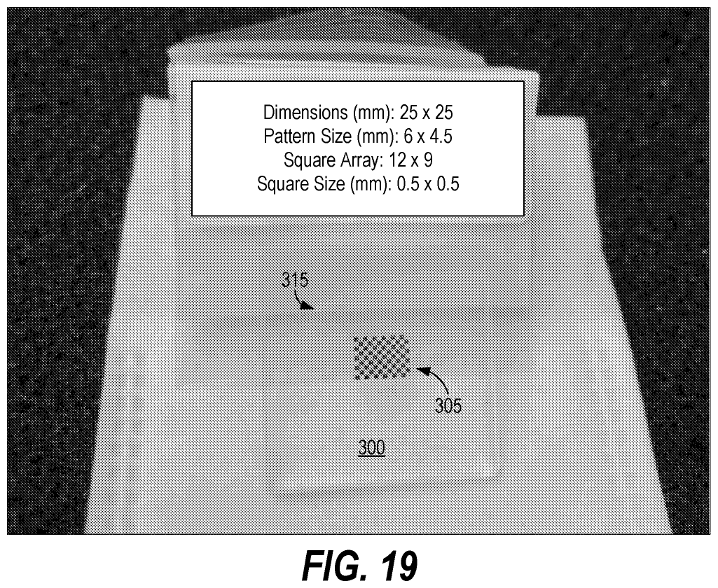

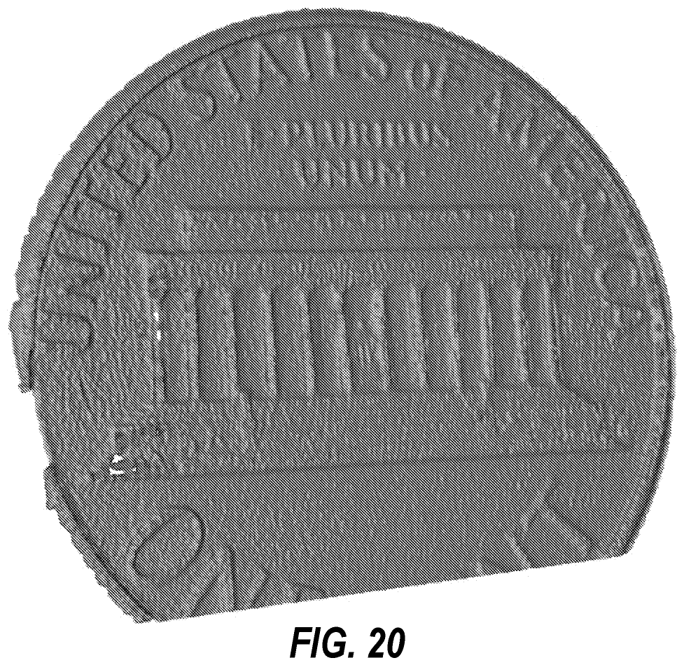

For local surface roughness analysis, ten 0.5×0.5 mm² sub-regions were picked randomly within each of the previously selected four 5×5 mm² square regions. The sub-regions and square regions are shown in FIG. 17. The aerial parameter Sa is calculated at each sub-region from the result of the structured light three-dimensional scanner 110 described herein, and compared with the result calculated based on the interferometry data. The same analysis is also performed for the benchmark scanner. The root mean squared error (RMSE), relative errors, and the standard deviations are calculated and shown in Table 2. To further illustrate and visualize the structured light three-dimensional scanner 110 described herein has better performance, correlation analysis has been performed for the aerial parameter Sa in each square region consider the aerial parameter Sa calculated from the interferometry data is the ground truth. The correlation plots are shown in FIG. 18.

TABLE 2
The RMSE, relative error, and the standard deviation of the surface roughness
result for the proposed and benchmark scanner at each square region (unit: μm).

| | Proposed Scanner | | | | Benchmark Scanner | | | |
|---|---|---|---|---|---|---|---|---|
| | | Error | Rel. | Rel. | | Error | Rel. | Rel. |
| | | (std. | error | error(std. | | (std. | error | error(std. |
| | RMSE | dev.) | (mean) | dev) | RMSE | dev.) | (mean) | dev) |
| Sub 1 | 2.00 | 1.28 | 9.42% | 6.07% | 15.1 | 11.5 | 106% | 98.5% |
| Sub 2 | 4.27 | 4.02 | 22.5% | 16.8% | 12.4 | 11.2 | 79.7% | 66.1% |
| Sub 3 | 2.26 | 2.25 | 14.1% | 7.62% | 22.6 | 11.6 | 137% | 67.0% |
| Sub 4 | 3.45 | 2.90 | 10.9% | 8.82% | 6.87 | 6.79 | 42.0% | 36.2% |
| Avg. | 2.99 | 2.61 | 14.2% | 9.82% | 14.2 | 10.3 | 91.2% | 67.0% |

In regard to surface area roughness analysis, the structured light three-dimensional scanner 110 described herein clearly outscores the benchmark scanner in terms of RMSE, relative error, standard deviation, and correlation. Notably, the structured light three-dimensional scanner 110 described herein has an RMSE of 2.99 μm with 2.61 μm standard deviations compared with 14.2 μm RMSE with 10.3 μm standard deviations for the benchmark scanner. In terms of relative error, the structured light three-dimensional scanner 110 described herein is 14.2% with a 9.82% standard deviation compared with 91.2% with a 67% standard deviation.

From FIG. 18, it is clear that there is a significant improvement in correlation. In all of the plots shown, positive linear correlations are observed. However, the correlation of the structured light three-dimensional scanner 110 described herein is significantly higher (closer to 100%) than the benchmark scanner with the ground truth. The correlation lines and data of the structured light three-dimensional scanner 110 described herein almost match with the 45° ground truth line in each region, while the lines and data from the benchmark scanner are less matching. The average aerial parameter Sa correlation score between measurements from the interferometer and the structured light three-dimensional scanner 110 described herein is 95.5%, compared to the benchmark scanner, which only has a correlation score of 40.8% (due to low spatial resolution and accuracy). From a quality control perspective, the surface roughness can be a good indicator of additive manufacturing part quality. For example, surface roughness has a strong correlation with fatigue performance because micro-notches associated with partially melted powders act as stress concentrators resulting in earlier crack initiation. The analysis in this section shows that only the structured light three-dimensional scanner 110 described herein can yield a reliable surface roughness result while the benchmark scanner cannot.

Accordingly, various embodiments for a high spatial resolution three-dimensional structured light three-dimensional scanner 110 is described. which has been built and calibrated. The structured light three-dimensional scanner 110 is able to meet the speed (second level) and resolution (micron level) requirements necessary for in-situ monitoring during metal additive manufacturing applications. The structured light three-dimensional scanner 110 can measure a surface with 5 μm spatial resolution so that it can resolve key surface features. It can also give high accuracy results with a 0.056 μm average error. Additionally, a calibration method and a set of calibration targets 300 are developed for the small field-of-view required in this work. Furthermore, it takes as few as four seconds for measurement, which is sufficient for layer-by-layer characterization and uses fifteen seconds of computational time to provide over sixteen million data points.

The efficacy of the structured light three-dimensional scanner 110 described herein is demonstrated by the characterization of surface roughness, curvature, and melt pool topography of an additive manufactured part. The performance of the three-dimensional scanner 110 described herein is validated by comparison with the benchmark scanner. The validation results conclude that the three-dimensional scanner 110 described herein has superior performance and can resolve more detailed melt pool features. In addition to the spatial resolution improvement (e.g., 5 μm compared with 50 μm), and the accuracy of the structured light three-dimensional scanner 110 described herein is 0.056 μm compared to 10.6 μm by the benchmark scanner. The surface roughness result of the structured light three-dimensional scanner 110 described herein has a 95.42% average correlation with the ground truth compared to 46.9% by the benchmark scanner.

The efficiency of this scanner can meet L-PBF online sensing requirements. During scanning, only the four-second image capturing time will delay the printing, but it is insignificant compared to the printing time of each layer, which is typically over twenty seconds. Regarding the fifteen-second computational time, it can be performed simultaneously with the printing of the next layer. Utilizing the printing time of the next layer to perform calculations will result in a one-layer delay of the defect mitigation. However, this delay will not significantly influence the effectiveness of defect mitigation since the thickness of one layer (typically only 50 to 100 μm) is negligible.

The efficiency of the structured light three-dimensional scanner 110 can be further improved by partial scans at each layer. For example, scans may be performed in critical regions such as over-hang structures and complex geometries where the processing conditions are highly non-equilibrium. The partial scan needs a reduced field-of-view and thus will reduce the computational time (e.g., fifteen seconds) accordingly. Additionally, the scan could be performed to sample several layers of deposit at a time. Due to the thin-layer-printing property of L-PBF, it may not be necessary to scan every single layer unless an abnormality has been detected or a critical region is being printed. Properly defining the sampling strategy will further improve the efficiency of the structured light three-dimensional scanner 110.

While various embodiments described herein relate to the scanner 110 being configured to have a 5 μm spatial resolution, the disclosure is not so limited. A follow-up experiment shows by using a calibration target 300 having example dimensions of 6×4.5 mm, shown in FIG. 10, the spatial resolution of the scanner 110 can achieve 2 μm. The calibration target 300 may include a ceramic substrate. In some embodiments, the ceramic substrate may be treated (e.g., chemically treated) to provide a matt white finish that is opaque. Here, the ceramic calibration target does not need a white background because the ceramic itself is white.

However, in some implementations, soda-lime glass and other transparent substrates may be employed. As such, for transparent ceramics, a uniform white background may be needed. A background (e.g., a white background) can be positioned outside of a depth of field of the scanner 110 such that any minor texture on the background can be blurred, forming a true uniform white background. Transparent calibration targets, such as the soda-lime glass substrate described herein, provide a calibration target with minimal or no surface imperfections. Therefore, calibration may be more accurate.

A calibration pattern 505 may be etched or otherwise formed on the ceramic substrate of the calibration target 300. For instance, the calibration pattern 505 may be formed on the calibration target 300 using at least one of physical vapor deposition (PVD) and laser etching methods. In some implementations, a material deposited on the ceramic substrate is a metallic material, such as chrome. Accordingly, the two imaging devices 120, 125 of the scanner 110 can be adjusted to an 8×6 mm field-of-view. The calibration target 300 can then be placed in front of a uniform white background, such as a uniform white color ceramic plate or other suitable background. Additional illumination can be applied only to the plate, for example, to make the clear calibration pattern appear to “float” in a calibration space, in images captured by the imaging devices 120, 125. This allows the imaging devices 120, 125 to capture clear and high-contrast calibration images and generate high-accuracy calibration results.

In some embodiments, the controller 130 includes at least one processor circuit, for example, having a hardware processor and a memory, both of which are coupled to a local interface. To this end. the controller 130 may include, for example, at least one server computer, a client device (e.g., mobile phone, tablet, laptop, personal computer, etc.), or like device. The local interface may include, for example, a data bus with an accompanying address/control bus or other bus structure as can be appreciated. The controller may have stored in memory both data and several components that are executable by the processor. In particular, stored in the memory and executable by the processor are applications, services, engines, modules, and the like that direct control of the projector 115, the imaging devices 120, 125, the lighting device (not shown). and potentially other applications. Also stored in the memory may be a data store and other data. In addition, an operating system may be stored in the memory and executable by the processor.

While in some embodiments, two imaging devices 120, 125 are implemented to form a dual-camera structured light three-dimensional scanner 110 scanner 110, in alternative embodiments, a single imaging device 120 may be implemented. For instance, the structured light three-dimensional scanner 110 may include a surface of an object 205 may be a first location, the projector 115 may be a second location, and the imaging device 120 may be at a third location. The projector 115 may project a calibration pattern onto the calibration target to calibrate using triangulation. To this end, the projector 115 may project a first predetermined pattern during calibration and a second predetermined pattern during measurement. For instance, the projector 115 may project a set of fringe patterns on a calibration target 300 during calibration, which is used for calibrating the scanner 110, and the projector 115 may project one or more fringe patterns (e.g., a sinusoidal fringe pattern) for measuring an object 205.

A number of software components may be stored in the memory and are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor, source code that may be expressed in proper format such as object code that is capable of being loaded into a random access portion of the memory and executed by the processor, or source code that may be interpreted by another executable program to generate instructions in a random access portion of the memory to be executed by the processor, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor may represent multiple processors and/or multiple processor cores and the memory may represent multiple memories that operate in parallel processing circuits. respectively. In such a case, the local interface may be an appropriate network that facilitates communication between any two of the multiple processors, between any processor and any of the memories, or between any two of the memories, etc. The local interface may comprise additional systems designed to coordinate this communication, including, for example, performing load balancing or communicating data (e.g., three-dimensional reconstruction data) to an additive manufacturing device, for example. The processor may be of electrical or of some other available construction.

Although the operations of the controller 130 described herein may be embodied in software or code executed by general purpose hardware as discussed above, as an alternative the same may also be embodied in dedicated hardware or a combination of software/general purpose hardware and dedicated hardware. If embodied in dedicated hardware, each function or task can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including functions performed by the controller 130, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition. the computer-readable medium may be a read-only memory (ROM), a programmable read-only memory (PROM), an erasable programmable read-only memory (EPROM), an electrically erasable programmable read-only memory (EEPROM), or other type of memory device.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method for scanning an object, comprising:
providing a structured light three-dimensional scanner (SLS) comprising: at least one imaging device having a lens and a controller, wherein the at least one imaging device has a field-of-view less than or equal to 50×50 mm;
capturing, by the at least one imaging device, calibration images of a calibration target having a predetermined pattern thereon;
calibrating, by the controller, the structured light three-dimensional scanner using the calibration images;
capturing, by the at least one imaging device, images of the object to be scanned; and
performing, by the controller, triangulation based on the images captured of the object to generate three-dimensional data of the object, wherein the three-dimensional data has a spatial resolution of 2 to 50 μm.

2. The method according to claim 1, wherein:
the at least one imaging device is a single imaging device;
the structured light three-dimensional scanner further comprises a projector;
the method further comprises directing, by the controller, the projector to project the predetermined pattern onto the calibration target; and
capturing, by the at least one imaging device, the calibration images of the calibration target as the predetermined pattern is projected on the calibration target by the projector.

3. The method according to claim 1, wherein capturing the calibration images of the calibration target further comprises: directing, by the controller, a lighting device to project light parallel to the calibration target.

4. The method according to claim 3, wherein the lighting device comprises a polarizer configured to enhance beam parallelism.

5. The method according to claim 2, wherein capturing the calibration images of the calibration target further comprises:
directing, by the controller, the projector to project light on the calibration target; and
directing, by the controller, a lighting device separate from the projector to project light parallel to the calibration target.

6. The method according to claim 1, wherein capturing the calibration images of the calibration target further comprises: adjusting an exposure time of the at least one imaging device to perform overexposure while capturing the calibration images.

7. The method according to claim 1, wherein the calibration target is a substrate having the predetermined pattern formed thereon, and wherein the predetermined pattern is a checkerboard pattern.

8. The method according to claim 7, wherein the substrate is a ceramic or transparent substrate and the predetermined pattern is formed of a metallic material through physical vapor deposition (PVD).

9. The method according to claim 1, wherein the calibration target is approximately 4.5×6.0 mm to 15×20 mm (e.g., ±5%).

10. The method according to claim 1, further comprising generating the three-dimensional data of the object during an additive manufacturing (AM) process in which another object separate from the object being scanned is formed.

11. The method according to claim 1, wherein the at least one imaging device is a first imaging device and a second imaging device collectively having a field-of-view less than or equal to 50×50 mm.

12. A system for scanning an object, comprising:
a structured light three-dimensional scanner (SLS) comprising: at least one imaging device having a lens and a controller, wherein the at least one imaging device has a field-of-view less than or equal to 50×50 mm, wherein the controller is configured to:
direct the at least one imaging device to capture calibration images of a calibration target, the calibration target having a predetermined pattern thereon;
calibrate the structured light three-dimensional scanner using the calibration images;
direct the at least one imaging device to capture images of the object to be scanned; and
perform triangulation based on the images captured of the object to generate three-dimensional data of the object, wherein the three-dimensional data has a spatial resolution of 2 to 50 μm.

13. The system according to claim 12, wherein:
the at least one imaging device is a single imaging device;
the structured light three-dimensional scanner further comprises a projector; and
the controller is further configured to direct the projector to project the predetermined pattern onto the calibration target, and direct the at least one imaging device to capture the calibration images of the calibration target as the predetermined pattern is projected on the calibration target by the projector.

14. The system according to claim 12, wherein the controller is further configured to direct a lighting device to project light parallel to the calibration target, and direct the first imaging device and the second imaging device to capture the calibration images of the calibration target as the lighting device projects the light parallel to the calibration target.

15. The system according to claim 14, wherein the lighting device comprises a polarizer configured to enhance beam parallelism.

16. The system according to claim 13, wherein the controller is further configured to:
direct the projector to project light on the calibration target; and
direct a lighting device separate from the projector to project light parallel to the calibration target as the calibration images are captured by the first imaging device and the second imaging device.

17. The system according to claim 12, wherein the at least one imaging device is a first imaging device and a second imaging device, and the controller is further configured to adjust an exposure time of at least one of the first imaging device and the second imaging device to perform overexposure as the calibration images are captured by the first imaging device and the second imaging device.

18. The system according to claim 12, wherein the calibration target is a substrate having the predetermined pattern formed thereon, and wherein the predetermined pattern is a checkerboard pattern.

19. The system according to claim 18, wherein the substrate is a ceramic or transparent substrate, and the predetermined pattern is formed of a metallic material through physical vapor deposition (PVD).

20. The system according to claim 12, wherein the calibration target is approximately 4.5×6.0 mm to 15×20 mm (e.g., ±5%).

21. The system according to claim 12, further comprising an additive manufacturing (AM) device, wherein the controller is configured to generate the three-dimensional data of the object during an additive manufacturing process in which another object separate from the object being scanned is formed by the additive manufacturing device and communicate the three-dimensional data to the additive manufacturing device as the other object is formed.

22. The system according to claim 12, wherein the at least one imaging device is a first imaging device and a second imaging device collectively having a field-of-view less than or equal to 50×50 mm.
